(19) United States
(12) Patent Application Publication
(10) Pub. No.: US 2024/0071388 A1
(43) Pub. Date: Feb. 29, 2024

(54) COMPUTER-READABLE RECORDING MEDIUM STORING DICTIONARY SELECTION PROGRAM, DICTIONARY SELECTION METHOD, AND DICTIONARY SELECTION DEVICE

(71) Applicant: Fujitsu Limited, Kawasaki-shi (JP)

(72) Inventor: Keisuke ASAKURA, Meguro (JP)

(73) Assignee: Fujitsu Limited, Kawasaki-shi (JP)

(21) Appl. No.: 18/344,166

(22) Filed: Jun. 29, 2023

(30) Foreign Application Priority Data
Aug. 25, 2022 (JP) 2022-134502

(51) Int. Cl. G10L 15/26

(52) U.S. Cl. CPC G10L 15/26

(57) ABSTRACT

A non-transitory computer-readable recording medium stores a dictionary selection program for causing a computer to execute a process including: determining genres indicated by moving image data for each of a plurality of sections in the moving image data, based on each of voice data and image data of the moving image data; determining quality of voice and the quality of an image for each of the plurality of sections in the moving image data, based on each of the voice data and the image data; and selecting voice recognition dictionaries that are specified, from among a plurality of the voice recognition dictionaries, based on determination results for the genres and the determination results for the quality of the voice and the quality of the image for each of the plurality of sections.

### CROSS-REFERENCE TO RELATED APPLICATION

This application is based upon and claims the benefit of priority of the prior Japanese Patent Application No. 2022-134502, filed on Aug. 25, 2022, the entire contents of which are incorporated herein by reference.

### FIELD

The embodiments discussed herein are related to a dictionary selection program, a dictionary selection method, and a dictionary selection device.

### BACKGROUND

Speech-to-text conversion, which is so-called dictation, has an aspect of being applied to voice data of a moving image. For example, voice data of a moving image in which a conference held through a chat function such as a voice call and a video is recorded by a recording function is input to a voice recognition engine, whereby speech-to-text transcription of the conference minutes, or the like is implemented.

Japanese Laid-open Patent Publication No. 2013-50605 is disclosed as related art.

### SUMMARY

According to an aspect of the embodiments, a non-transitory computer-readable recording medium stores a dictionary selection program for causing a computer to execute a process including: determining genres indicated by moving image data for each of a plurality of sections in the moving image data, based on each of voice data and image data of the moving image data; determining quality of voice and the quality of an image for each of the plurality of sections in the moving image data, based on each of the voice data and the image data; and selecting voice recognition dictionaries that are specified, from among a plurality of the voice recognition dictionaries, based on determination results for the genres and the determination results for the quality of the voice and the quality of the image for each of the plurality of sections.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a functional configuration example of a server device;

FIG. 2 is a diagram illustrating an example of a first genre determination model;

FIG. 3 is a diagram illustrating an example of a second genre determination model;

FIG. 4 is a diagram illustrating an example of a first quality determination model;

FIG. 5 is a diagram illustrating an example of a second quality determination model;

FIG. 6 is a schematic diagram (1) illustrating an example of selecting a genre;

FIG. 7 is a schematic diagram (2) illustrating an example of selecting a genre;

FIG. 8 is a schematic diagram (3) illustrating an example of selecting a genre;

FIG. 9 is a schematic diagram (4) illustrating an example of selecting a genre;

FIG. 10 is a schematic diagram (5) illustrating an example of selecting a genre;

FIG. 11 is a diagram illustrating an example of genre selection results;

FIG. 12 is a diagram illustrating an example of filtering results for character extraction results;

FIG. 13 is a diagram illustrating a schematic example of voice recognition;

FIG. 14 is a flowchart illustrating a procedure of dictionary selection processing; and

FIG. 15 is a diagram illustrating a hardware configuration example.

### DESCRIPTION OF EMBODIMENTS

The accuracy of the voice recognition in such speech-to-text transcription has an aspect of being affected by the word dictionary in which the vocabulary to be recognized by the voice recognition engine is registered. For example, a language model switching device is known as one of techniques for choosing one voice recognition dictionary from among a plurality of voice recognition dictionaries. For example, in a case where a plurality of language models adapted for each topic is prepared, the language model switching device estimates a topic currently in progress, using a voice recognition result, and sequentially switches the language model to one matching the estimated topic.

However, the above-described language model switching device has an aspect of having a difficulty in selecting a voice recognition dictionary corresponding to a genre of a moving image.

For example, in the above language model switching device, switching to a language model having low relevance to the topic in the moving image is executed due to factors exemplified below, and as a result, the voice recognition accuracy sometimes decreases. For example, when background music (BGM) or noise is superimposed on the input voice, it is difficult to grasp the features of the voice, and consequently, the estimation accuracy for the topic decreases. In addition, also in a case where a plurality of speakers is performing crosstalk, it is similarly difficult to grasp the features of the voice, and consequently, the estimation accuracy for the topic decreases. Furthermore, when the input voice includes a high percentage or frequency of silent sections, information that grasps the features of the voice is insufficient, and consequently, errors are likely to increase in estimation of the topic. As described above, in the above language model switching device, the estimation accuracy for the topic decreases when unexpected voice data such as noise, BGM, and crosstalk is input, and it is difficult to choose the voice recognition dictionary corresponding to the topic.

In one aspect, an object of the embodiments is to provide a dictionary selection program, a dictionary selection method, and a dictionary selection device capable of implementing selection of a voice recognition dictionary corresponding to a genre of a moving image.

Hereinafter, embodiments of a dictionary selection program, a dictionary selection method, and a dictionary selection device according to the present application will be described with reference to the accompanying drawings. Each of the embodiments merely illustrates an example or aspect, and such exemplification does not limit numerical values, a range of functions, usage scenes, and the like. Then, each of the embodiments can be appropriately combined within a range that does not cause contradiction between processing contents.

### First Embodiment

<System Configuration>

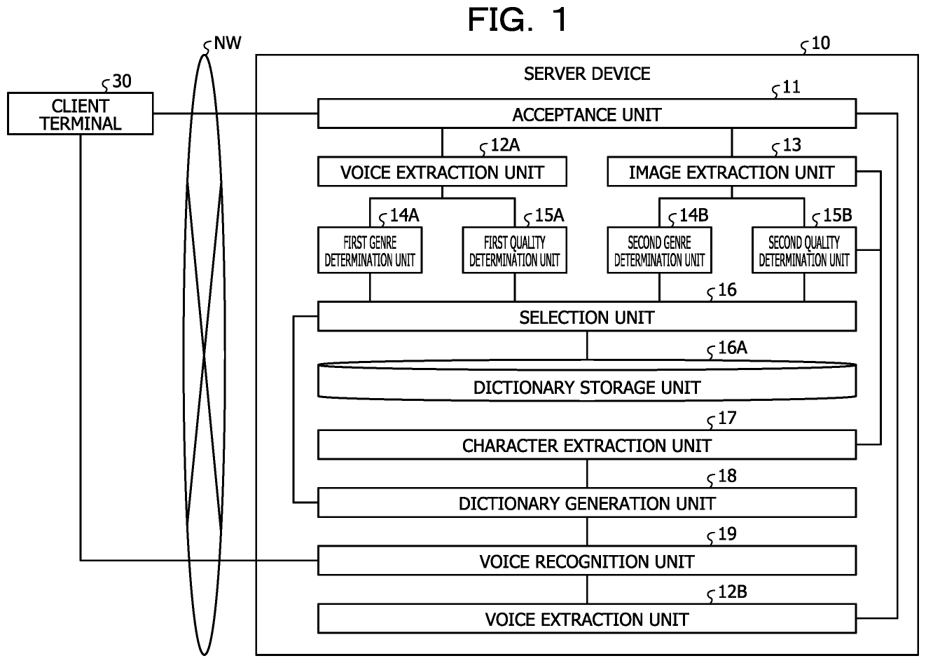

FIG. 1 is a block diagram illustrating a functional configuration example of a server device 10. The server device 10 illustrated in FIG. 1 is configured to provide a speech-to-text transcription function for generating text by applying speech-to-text conversion, which is so-called dictation, to voice data of a moving image.

As a mere example of usage scenes of such a speech-to-text transcription function, a scene can be mentioned in which, for example, a record of statements is generated by inputting, to a voice recognition engine, voice data of a moving image in which a conference or a lecture held through a chat function such as a voice call or a video is recorded.

The server device 10 is an example of a computer that provides the above-mentioned speech-to-text transcription function. For example, the server device 10 can be implemented as a server that provides the above speech-to-text transcription function on-premises. Additionally, by implementing the server device 10 as a platform as a service (PaaS) type or software as a service (SaaS) type application, the server device 10 can provide the above speech-to-text transcription function as a cloud service.

As illustrated in FIG. 1, the server device 10 can be coupled to a client terminal 30 via a network NW so as to enable communication. For example, the network NW may be any type of communication network such as the Internet or a local area network (LAN) regardless of whether the network NW is wired or wireless. Note that, although an example in which one client terminal 30 is coupled per one server device 10 has been given in FIG. 1, this does not exclude any number of client terminals 30 from being coupled.

The client terminal 30 corresponds to an example of a computer provided with the above speech-to-text transcription function. For example, the client terminal 30 may be implemented by a portable terminal device such as a smartphone, a tablet terminal, or a wearable terminal as well as a personal computer.

Note that FIG. 1 gives an example of a usage scene as a service in which the server device 10 provides the client terminal 30 with the above speech-to-text transcription function, but this is merely an example. For example, an application operating on the client terminal 30 may cause the client terminal 30 to execute processing corresponding to the above speech-to-text transcription function, whereby the above speech-to-text transcription function may be provided stand-alone.

<One Aspect of Problem>

As described in the background part, the above language model switching device has an aspect of having a difficulty in selecting a voice recognition dictionary corresponding to a genre of a moving image.

For example, in the above language model switching device, switching to a language model having low relevance to the topic in the moving image is executed due to factors exemplified below, and as a result, the voice recognition accuracy sometimes decreases. For example, when BGM or noise is superimposed on the input voice, it is difficult to grasp the features of the voice, and consequently, the estimation accuracy for the topic decreases. In addition, also in a case where a plurality of speakers is performing crosstalk, it is similarly difficult to grasp the features of the voice, and consequently, the estimation accuracy for the topic decreases. Furthermore, when the input voice includes a high percentage or frequency of silent sections, information that grasps the features of the voice is insufficient, and consequently, errors are likely to increase in estimation of the topic. As described above, in the above language model switching device, the estimation accuracy for the topic decreases when unexpected voice data such as noise, BGM, and crosstalk is input, and it is difficult to choose the voice recognition dictionary corresponding to the topic.

<One Aspect of Problem Solving Approach>

Thus, the speech-to-text transcription function according to the present embodiment is equipped with a dictionary selection function that selects a voice recognition dictionary corresponding to one genre among a genre determined from voice and a genre determined from an image in a moving image, based on the quality of the voice and the image of the moving image.

With such a dictionary selection function, for example, a voice recognition dictionary corresponding to the genre determined from the voice may be selected when the image has a poor quality in the moving image, or a voice recognition dictionary corresponding to the genre determined from the image may be selected when the voice has a poor quality in the moving image. Alternatively, for example, a voice recognition dictionary corresponding to the genre determined from the image may be selected when the image has a good quality in the moving image, or a voice recognition dictionary corresponding to the genre determined from the voice may be selected when the voice has a good quality in the moving image.

Therefore, according to the dictionary selection function according to the present embodiment, selection of a voice recognition dictionary corresponding to a genre of a moving image may be implemented.

<Configuration of Server Device 10>

Next, a functional configuration example of the server device 10 according to the present embodiment will be described. In FIG. 1, blocks related to the speech-to-text transcription function that the server device 10 has are schematically depicted.

As illustrated in FIG. 1, the server device 10 includes an acceptance unit 11, voice extraction units 12A and 12B, an image extraction unit 13, a first genre determination unit 14A, a second genre determination unit 14B, a first quality determination unit 15A, and a second quality determination unit 15B. The server device 10 further includes a dictionary storage unit 16A, a selection unit 16, a character extraction unit 17, a dictionary generation unit 18, and a voice recognition unit 19.

The acceptance unit 11, the voice extraction units 12A and 12B, the image extraction unit 13, the first genre determination unit 14A, the second genre determination unit 14B, the first quality determination unit 15A, the second quality determination unit 15B, the selection unit 16, the character extraction unit 17, the dictionary generation unit 18, the voice recognition unit 19, and the like will be referred to as functional units. Such functional units can be implemented by a hardware processor. For example, examples of the hardware processor include a central processing unit (CPU), a micro processing unit (MPU), a graphics processing unit (GPU), and a general-purpose computing on GPU (GPGPU). Additionally, the above functional units may be implemented by hard wired logic such as an application specific integrated circuit (ASIC) or a field programmable gate array (FPGA).

The storage unit such as the dictionary storage unit 16A can be implemented by various storages such as a hard disk drive (HDD), an optical disc, or a solid state drive (SSD), or by allocating a part of a storage area that a storage has.

The acceptance unit 11 is a processing unit that accepts various requests from the client terminal 30. As a mere example, the acceptance unit 11 can accept a speech-to-text transcription request for demanding the execution of speech-to-text transcription, from the client terminal 30.

When accepting such a speech-to-text transcription request, the acceptance unit 11 can also accept, for example, designation of a moving image to be subjected to speech-to-text transcription. As one aspect, the acceptance unit 11 can accept a moving image to be subjected to speech-to-text transcription from the client terminal 30 via the network NW. As another aspect, the acceptance unit 11 can also accept the designation from among moving images stored in a file server (not illustrated) or the like.

Both of the voice extraction units 12A and 12B are processing units that extract voice data from a moving image. These voice extraction units 12A and 12B have different sections of voice data to be separated from the moving image.

As one aspect, the voice extraction unit 12A extracts voice data corresponding to a section corresponding to a specified analysis frame length, for each of the sections among all sections of the moving image. As a mere example, the voice extraction unit 12A extracts frames having a specified time length in order from the head of the voice data for all sections separated from the moving image, for each frame period, and applies a window function such as the hanning window. At this time, from the aspect of reducing information loss due to the window function, the voice extraction unit 12A is allowed to cause the preceding and succeeding analysis frames to overlap at an optional percentage. For example, by setting a fixed length such as 512 samples as the analysis frame length at regular intervals, such as at every frame period of 256 samples, the overlap ratio can be set to 50%. The voice data extracted for each section corresponding to the analysis frame length in this manner is output to the first genre determination unit 14A to be described later and the first quality determination unit 15A to be described later.

As another aspect, the voice extraction unit 12B extracts voice data corresponding to all sections of the moving image. The voice data corresponding to all sections obtained in this manner is output to the voice recognition unit 19 to be described later.

The image extraction unit 13 is a processing unit that extracts image data from a moving image. As a mere example, the image extraction unit 13 extracts image data corresponding to a section from which voice data is extracted by the voice extraction unit 12A, in synchronization with the voice extraction unit 12A for each of the sections. The image data extracted for each section in this manner is output to the second genre determination unit 14B to be described later and the second quality determination unit 15B to be described later.

The first genre determination unit 14A is a processing unit that determines a genre of the moving image, based on the voice data extracted by voice extraction unit 12A. Such genre determination can be implemented by a machine learning model that executes a class classification task of outputting confidence levels for each genre class with the voice data as input, as a mere example. For example, the machine learning model may be implemented by a neural network such as a long short-term memory (LSTM) or a convolutional neural network (CNN) used for the voice recognition task. Hereinafter, from the aspect of distinguishing the above machine learning model from other machine learning models, the above machine learning model will be sometimes referred to by the expression “first genre determination model”.

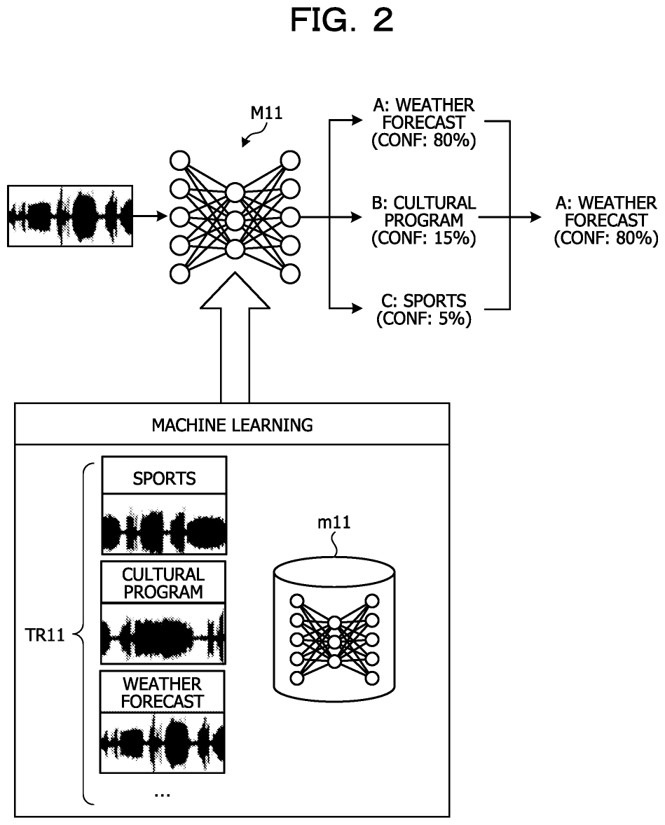

FIG. 2 is a diagram illustrating an example of the first genre determination model. As illustrated in FIG. 2, a first genre determination model m11 is used for genre determination using the voice data. For the training of this first genre determination model m11, a dataset TR11 including training data in which the voice signal corresponding to the time length of one section and a correct answer label of a genre are associated with each other can be used. For example, in FIG. 2, as a mere example of the dataset TR11, three pieces of the training data in which the voice signal corresponding to the time length of one section is associated with each one of the correct answer labels of three genres “sports”, “cultural program”, and “weather forecast” are excerpted and exemplified. Hereinafter, the voice signal corresponding to the time length of one section will be sometimes referred to by the expression “section voice signal”.

For example, in the training phase, the first genre determination model m11 can be trained in accordance with any machine learning algorithm such as deep learning, with the section voice signal as an explanatory variable for the first genre determination model m11 and the label as an objective variable for the first genre determination model m11. This obtains a trained first genre determination model M11.

In the inference phase, the section voice signal extracted by the voice extraction unit 12A is input to the first genre determination model M11. The first genre determination model M11 to which the section voice signal has been input in this manner outputs the confidence levels for each genre class. For example, “80%” is output as the confidence level of the genre class “weather forecast”. Furthermore, “15%” is output as the confidence level of the genre class “cultural program”. Furthermore, “5%” is output as the confidence level of the genre class “sports”. In this case, as a mere example, the class “weather forecast” having the highest confidence level can be regarded as the determination result for the genre.

Note that, although an example of inputting the voice signal to the first genre determination model M11 has been given here, the whole voice signal is not necessarily restrictive, but for example, a feature or the like obtained by feature extraction for the voice signal may be input to the first genre determination model M11.

The second genre determination unit 14B is a processing unit that determines a genre of the moving image, based on the image data extracted by the image extraction unit 13. Such genre determination can be implemented by a machine learning model that executes a class classification task of outputting confidence levels for each genre class with the image data as input, as a mere example. For example, the machine learning model may be implemented by a convolutional neural network used for the image recognition task, which is a so-called CNN-based neural network. Hereinafter, from the aspect of distinguishing the machine learning model described in the present part from other machine learning models, the machine learning model described in the present part will be sometimes referred to by the expression “second genre determination model”.

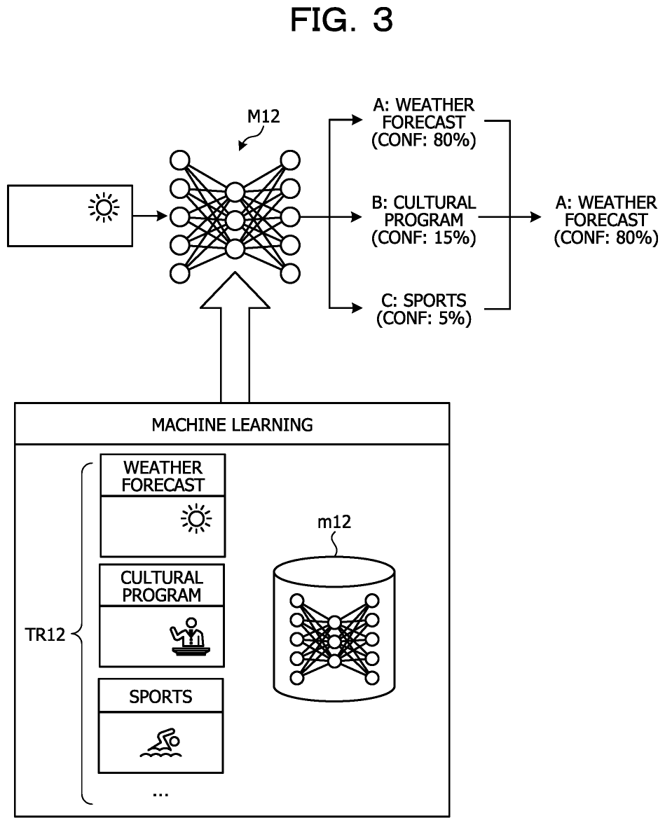

FIG. 3 is a diagram illustrating an example of the second genre determination model. As illustrated in FIG. 3, a second genre determination model m12 is used for genre determination using the image data. For the training of this second genre determination model m12, a dataset TR12 including training data in which an image included in one section and a correct answer label of a genre are associated with each other can be used. For example, in FIG. 3, as a mere example of the dataset TR12, three pieces of the training data in which an image included in one section is associated with each one of the correct answer labels of three genres “weather forecast”, “cultural program”, and “sports” are excerpted and exemplified. Note that FIG. 3 gives an example in which an image included in one section has one frame, but this does not exclude an image with any number of frames from being included.

For example, in the training phase, the second genre determination model m12 can be trained in accordance with any machine learning algorithm such as deep learning, with the image as an explanatory variable for the second genre determination model m12 and the label as an objective variable for the second genre determination model m12. This obtains a trained second genre determination model M12.

In the inference phase, the image extracted by the image extraction unit 13 is input to the second genre determination model M12. The second genre determination model M12 to which the image has been input in this manner outputs the confidence levels for each genre class. For example, “80%” is output as the confidence level of the genre class “weather forecast”. Furthermore, “15%” is output as the confidence level of the genre class “cultural program”. Furthermore, “5%” is output as the confidence level of the genre class “sports”. In this case, as a mere example, the class “weather forecast” having the highest confidence level can be regarded as the determination result for the genre.

Note that, although FIGS. 2 and 3 give an example in which the first genre determination model M11 and the second genre determination model M12 are configured for classification into the three classes of weather forecast, sports program, and cultural program, the classes are not limited to these. For example, apart from the weather forecast, the sports program, and the cultural program, classes such as a variety show and a talk show may be further adopted for classification, and any classes may be included as the classification targets as long as two or more classes are involved.

The first quality determination unit 15A is a processing unit that determines the quality relating to the voice in the moving image, based on the voice data extracted by the voice extraction unit 12A. Such determination of the voice quality can be implemented by a machine learning model that executes a class classification task of outputting confidence levels for each quality class relating to the voice, with the voice data as input, as a mere example. For example, the machine learning model may be implemented by a neural network such as an LSTM or a CNN. Hereinafter, from the aspect of distinguishing the machine learning model described in the present part from other machine learning models, the machine learning model described in the present part will be sometimes referred to by the expression “first quality determination model”.

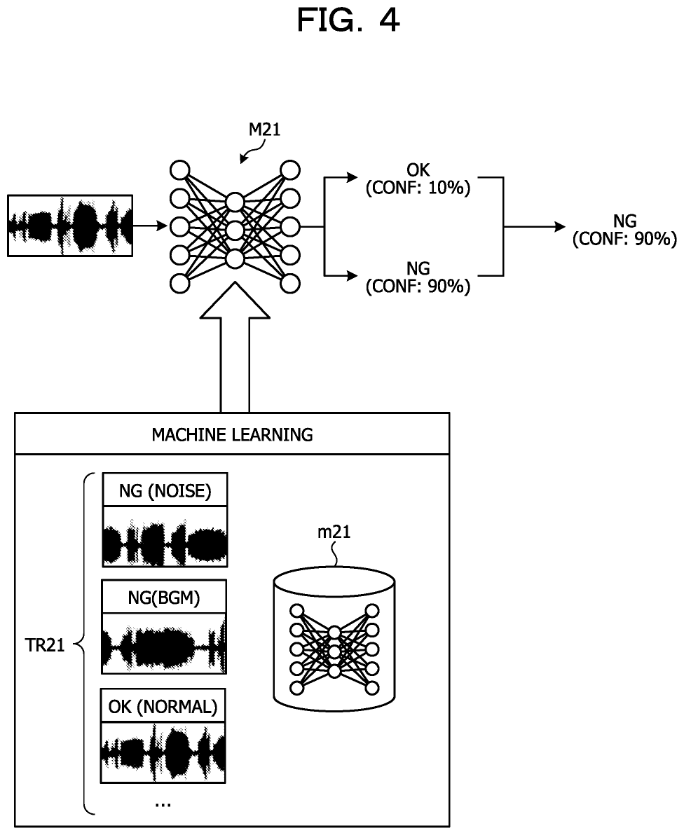

FIG. 4 is a diagram illustrating an example of the first quality determination model. As illustrated in FIG. 4, a first quality determination model m21 is used for determination of the voice quality. For the training of this first quality determination model m21, a dataset TR21 including training data in which the section voice signal and a correct answer label of quality are associated with each other can be used. For example, in FIG. 4, as a mere example of the dataset TR21, three pieces of the training data in which the section voice signal is associated with one of three correct answer labels “NG (noise)”, “NG (BGM)”, and “OK (normal)” are excerpted and exemplified.

For example, in the training phase, the first quality determination model m21 can be trained in accordance with any machine learning algorithm such as deep learning, with the section voice signal as an explanatory variable for the first quality determination model m21 and the label as an objective variable for the first quality determination model m21. This obtains a trained first quality determination model M21.

In the inference phase, the section voice signal extracted by the voice extraction unit 12A is input to the first quality determination model M21. The first quality determination model M21 to which the section voice signal has been input in this manner outputs the confidence levels for each voice quality class. For example, “10%” is output as the confidence level of the voice quality class “OK”, whereas “90%” is output as the confidence level of the voice quality class “NG”. In this case, as a mere example, the class “NG” having the highest confidence level can be regarded as the determination result for the voice quality.

Note that, although an example of inputting the voice signal to the first quality determination model M21 has been given here, the whole voice signal is not necessarily restrictive, but for example, a feature or the like obtained by feature extraction for the voice signal may be input to the first quality determination model M21. In addition, although an example in which the machine learning task of the first quality determination model M21 is two-class classification that classifies the voice data into two classes of OK and NG has been given here, the machine learning task of the first quality determination model M21 is not limited to this. For example, the machine learning task of the first quality determination model M21 may be multi-class classification that classifies the voice data into multiple classes equal to or more than three, such as noise, BGM, crosstalk, and normal.

The second quality determination unit 15B is a processing unit that determines the quality relating to the image in the moving image, based on the image data extracted by the image extraction unit 13. Such determination of the image quality can be implemented by a machine learning model that executes a class classification task of outputting confidence levels for each image quality class with the image data as input, as a mere example. For example, the machine learning model may be implemented by a CNN-based neural network. Hereinafter, from the aspect of distinguishing the machine learning model described in the present part from other machine learning models, the machine learning model described in the present part will be sometimes referred to by the expression “second quality determination model”.

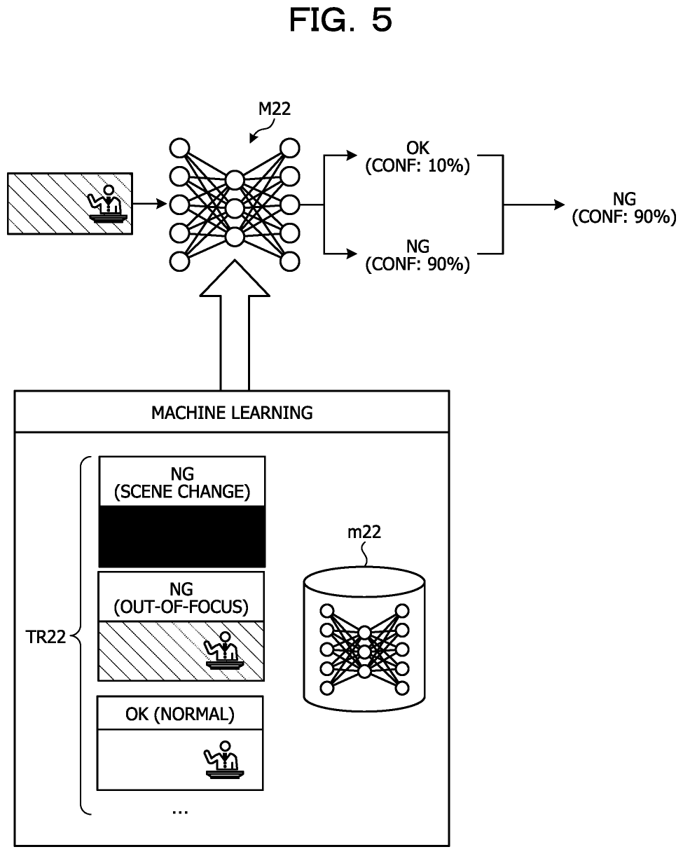

FIG. 5 is a diagram illustrating an example of the second quality determination model. As illustrated in FIG. 5, a second quality determination model m22 is used for determination of the image quality. For the training of this second quality determination model m22, a dataset TR22 including training data in which an image included in one section and a correct answer label of image quality are associated with each other can be used. For example, in FIG. 5, as a mere example of the dataset TR22, three pieces of training data in which an image included in one section is associated with each one of three correct answer labels “NG (scene change)”, “NG (out-of-focus)”, and “OK (normal)” are excerpted and exemplified. Note that FIG. 5 gives an example in which an image included in one section has one frame, but this does not exclude an image with any number of frames from being included.

For example, in the training phase, the second quality determination model m22 can be trained in accordance with any machine learning algorithm such as deep learning, with the image as an explanatory variable for the second quality determination model m22 and the label as an objective variable for the second quality determination model m22. This obtains a trained second quality determination model M22.

In the inference phase, the image extracted by the image extraction unit 13 is input to the second quality determination model M22. The second quality determination model M22 to which the image has been input in this manner outputs the confidence levels for each image quality class. For example, “10%” is output as the confidence level of the image quality class “OK”, whereas “90%” is output as the confidence level of the image quality class “NG”. In this case, as a mere example, the class “NG” having the highest confidence level can be regarded as the determination result for the image quality.

Note that, although an example in which the machine learning task of the second quality determination model M22 is two-class classification that classifies the image data into two classes of OK and NG has been given here, the machine learning task of the second quality determination model M22 is not limited to this. For example, the machine learning task of the second quality determination model M22 may be multi-class classification that classifies the image data into multiple classes equal to or more than three, such as scene change, out-of-focus, and normal.

The selection unit 16 is a processing unit that selects a specified voice recognition dictionary from among a plurality of voice recognition dictionaries, based on the determination result for the genre and the determination results for the voice quality and image quality, for each of a plurality of sections.

For example, the selection unit 16 executes the processing as follows for each section. For example, the selection unit 16 compares the voice quality determined by the first quality determination unit 15A and the image quality determined by the second quality determination unit 15B, thereby selecting a medium with the better quality from among the two media of voice and image. Then, the selection unit 16 selects the genre corresponding to the medium with the better quality from among the genre determined from the voice by the first genre determination unit 14A and the genre determined from the image by the second genre determination unit 14B. After that, the selection unit 16 selects the voice recognition dictionary corresponding to the genre having the highest selection frequency among the genres selected for each section, from among a plurality of voice recognition dictionaries stored in the dictionary storage unit 16A.

Such a dictionary storage unit 16A may store, as a mere example, voice recognition dictionaries specialized in each genre, for each genre. The “voice recognition dictionary” mentioned here may include a “word dictionary” listing vocabularies, for example, a set of words, to be subjected to recognition by the voice recognition engine. Additionally, the “voice recognition dictionary” may also include, for example, a grammar of a language, a “language model” in which an occurrence probability or the like of a word string is defined, for example, and an “acoustic model” in which a feature pattern of an acoustic sound is defined in units of phonemes or the like. For example, by generating a word dictionary, a language model, and an acoustic model based on a corpus corresponding to a specified genre, a voice recognition dictionary for the specified genre can be generated. In accordance with the examples illustrated in FIGS. 2 and 3, voice recognition dictionaries for weather forecast specialized in the genre “weather forecast”, for cultural program specialized in the genre “cultural program”, and for sports specialized in the genre “sports” can be saved in the dictionary storage unit 16A.

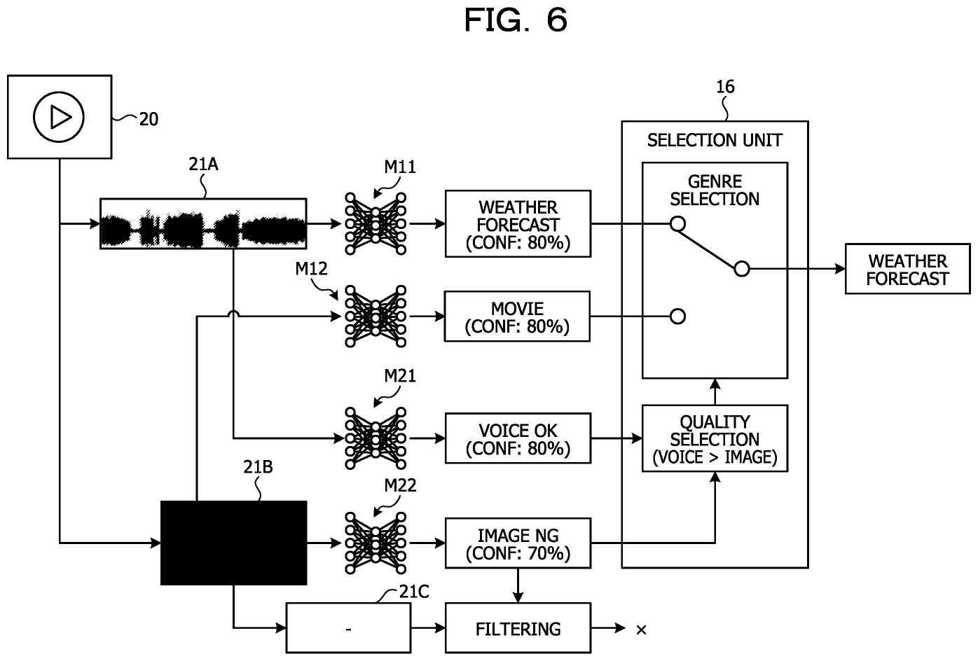

An example of selecting a genre by the selection unit 16 will be described with reference to FIGS. 6 to 10. FIGS. 6 to 10 are schematic diagrams (1) to (5) illustrating an example of selecting a genre. As a mere example, FIGS. 6 to 10 schematically depict an algorithm by which the selection unit 16 selects genres of sections (a) to (e) in chronological order, among a plurality of sections obtained by splitting a moving image 20 for which a speech-to-text transcription request has been accepted.

For example, in FIG. 6, a section voice signal 21A is extracted by the voice extraction unit 12A from the section (a) of the moving image 20. In this case, the section voice signal 21A is input to the first genre determination model M11 and the first quality determination model M21. In addition, an example in which an image 21B is extracted by the image extraction unit 13 from the section (a) of the moving image 20 is illustrated. In this case, the image 21B is input to the second genre determination model M12 and the second quality determination model M22.

The first genre determination model M11 to which the section voice signal 21A has been input in this manner outputs the genre label “weather forecast (confidence level of 80%)” having the highest confidence level among the confidence levels for each genre class, to the selection unit 16. Furthermore, the second genre determination model M12 to which the image 21B has been input outputs the genre label “movie (confidence level of 80%)” having the highest confidence level among the confidence levels for each genre class, to the selection unit 16. Furthermore, the first quality determination model M21 to which the section voice signal 21A has been input outputs the voice quality label “OK (confidence level of 80%)” having the highest confidence level among the confidence levels for each voice quality class, to the selection unit 16. Furthermore, the second quality determination model M22 to which the image 21B has been input outputs the image quality label “NG (confidence level of 70%)” having the highest confidence level among the confidence levels for each image quality class, to the selection unit 16.

The selection unit 16 that has accepted such input compares the voice quality label “OK (confidence level of 80%)” output by the first quality determination model M21 and the image quality label “NG (confidence level of 70%)” output by the second quality determination model M22. In this case, since the voice quality is superior to the image quality, the medium “voice” having the better quality is selected from among the two media of voice and image. As a result, the genre “weather forecast” corresponding to the medium “voice” having the better quality is selected from among the genre label “weather forecast” output by the first genre determination model M11 and the genre label “movie” output by the second genre determination model M12.

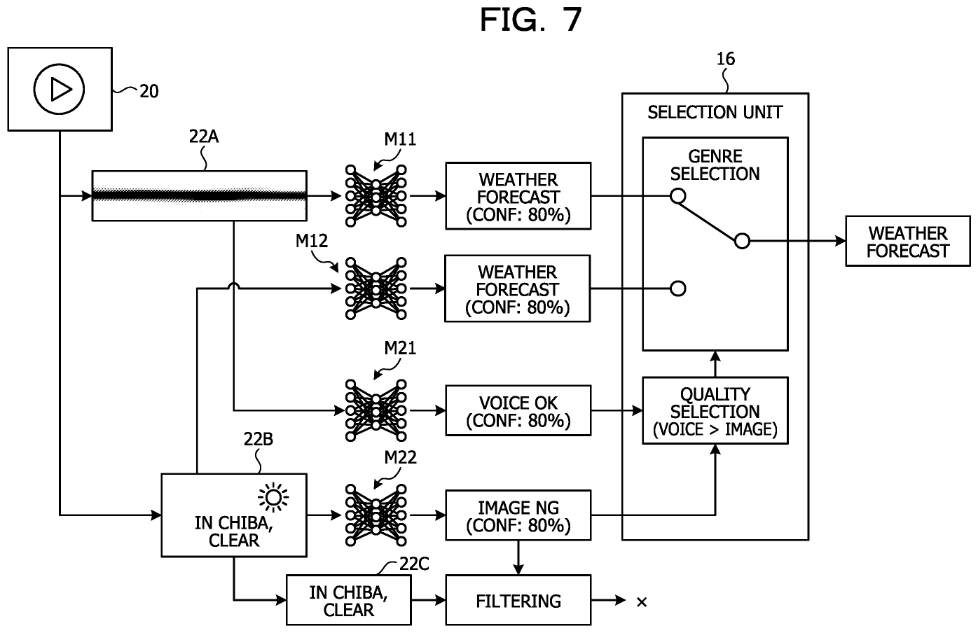

Next, in FIG. 7, a section voice signal 22A is extracted by the voice extraction unit 12A from the section (b) of the moving image 20. In this case, the section voice signal 22A is input to the first genre determination model M11 and the first quality determination model M21. In addition, an example in which an image 22B is extracted by the image extraction unit 13 from the section (b) of the moving image 20 is illustrated. In this case, the image 22B is input to the second genre determination model M12 and the second quality determination model M22.

The first genre determination model M11 to which the section voice signal 22A has been input in this manner outputs the genre label “weather forecast (confidence level of 80%)” having the highest confidence level among the confidence levels for each genre class, to the selection unit 16. Furthermore, the second genre determination model M12 to which the image 22B has been input outputs the genre label “weather forecast (confidence level of 80%)” having the highest confidence level among the confidence levels for each genre class, to the selection unit 16. Furthermore, the first quality determination model M21 to which the section voice signal 22A has been input outputs the voice quality label “OK (confidence level of 80%)” having the highest confidence level among the confidence levels for each voice quality class, to the selection unit 16. Furthermore, the second quality determination model M22 to which the image 22B has been input outputs the image quality label “NG (confidence level of 80%)” having the highest confidence level among the confidence levels for each image quality class, to the selection unit 16.

The selection unit 16 that has accepted such input compares the voice quality label “OK (confidence level of 80%)” output by the first quality determination model M21 and the image quality label “NG (confidence level of 80%)” output by the second quality determination model M22. In this case, since the voice quality is superior to the image quality, the medium “voice” having the better quality is selected from among the two media of voice and image. As a result, the genre “weather forecast” corresponding to the medium “voice” having the better quality is selected from among the genre label “weather forecast” output by the first genre determination model M11 and the genre label “weather forecast” output by the second genre determination model M12. Note that, as in the example of the section (b), when the first genre determination model M11 and the second genre determination model M12 output the same genre label, the comparison between the voice quality and the image quality may be skipped.

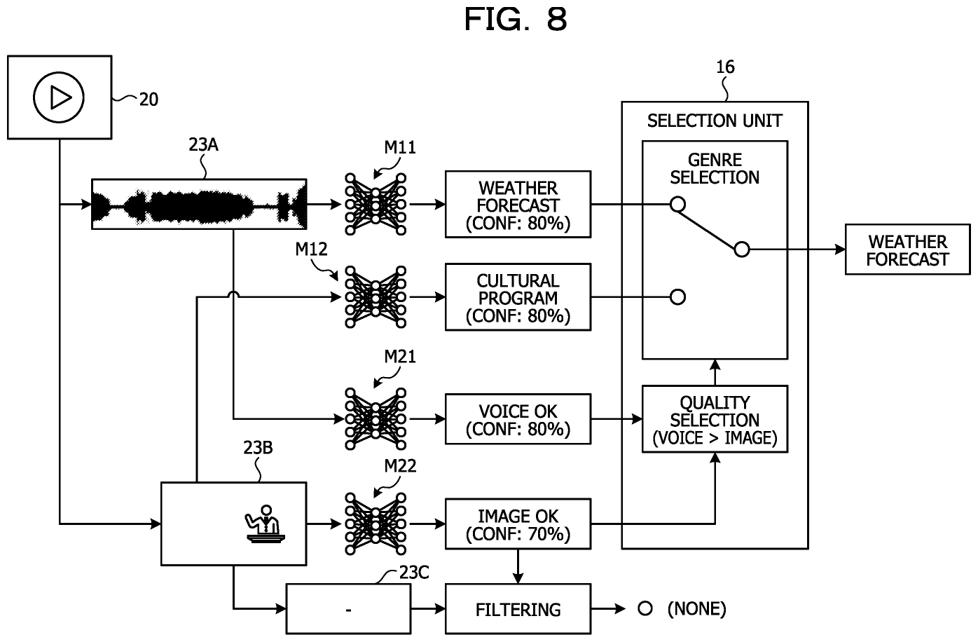

Next, in FIG. 8, a section voice signal 23A is extracted by the voice extraction unit 12A from the section (c) of the moving image 20. In this case, the section voice signal 23A is input to the first genre determination model M11 and the first quality determination model M21. In addition, an example in which an image 23B is extracted by the image extraction unit 13 from the section (c) of the moving image 20 is illustrated. In this case, the image 23B is input to the second genre determination model M12 and the second quality determination model M22.

The first genre determination model M11 to which the section voice signal 23A has been input in this manner outputs the genre label “weather forecast (confidence level of 80%)” having the highest confidence level among the confidence levels for each genre class, to the selection unit 16. Furthermore, the second genre determination model M12 to which the image 23B has been input outputs the genre label “cultural program (confidence level of 80%)” having the highest confidence level among the confidence levels for each genre class, to the selection unit 16. Furthermore, the first quality determination model M21 to which the section voice signal 23A has been input outputs the voice quality label “OK (confidence level of 80%)” having the highest confidence level among the confidence levels for each voice quality class, to the selection unit 16. Furthermore, the second quality determination model M22 to which the image 23B has been input outputs the image quality label “OK (confidence level of 70%)” having the highest confidence level among the confidence levels for each image quality class, to the selection unit 16.

The selection unit 16 that has accepted such input compares the voice quality label “OK (confidence level of 80%)” output by the first quality determination model M21 and the image quality label “OK (confidence level of 70%)” output by the second quality determination model M22. In this case, since the voice quality is superior to the image quality, the medium “voice” having the better quality is selected from among the two media of voice and image. As a result, the genre “weather forecast” corresponding to the medium “voice” having the better quality is selected from among the genre label “weather forecast” output by the first genre determination model M11 and the genre label “cultural program” output by the second genre determination model M12.

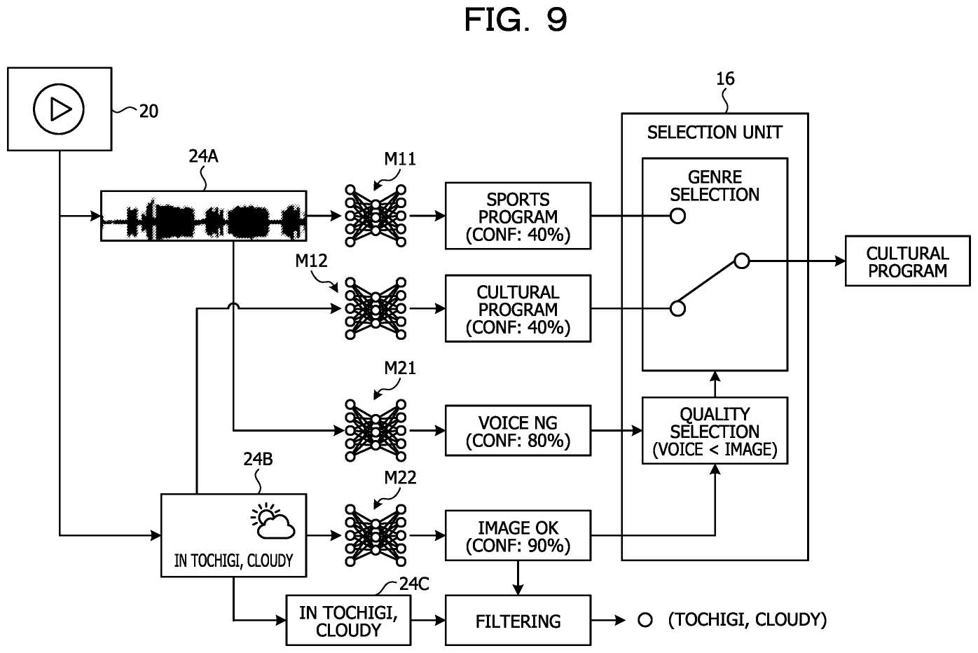

Next, in FIG. 9, a section voice signal 24A is extracted by the voice extraction unit 12A from the section (d) of the moving image 20. In this case, the section voice signal 24A is input to the first genre determination model M11 and the first quality determination model M21. In addition, an example in which an image 24B is extracted by the image extraction unit 13 from the section (d) of the moving image 20 is illustrated. In this case, the image 24B is input to the second genre determination model M12 and the second quality determination model M22.

The first genre determination model M11 to which the section voice signal 24A has been input in this manner outputs the genre label “sports program (confidence level of 40%)” having the highest confidence level among the confidence levels for each genre class, to the selection unit 16. Furthermore, the second genre determination model M12 to which the image 24B has been input outputs the genre label “cultural program (confidence level of 40%)” having the highest confidence level among the confidence levels for each genre class, to the selection unit 16. Furthermore, the first quality determination model M21 to which the section voice signal 24A has been input outputs the voice quality label “NG (confidence level of 80%)” having the highest confidence level among the confidence levels for each voice quality class, to the selection unit 16. Furthermore, the second quality determination model M22 to which the image 24B has been input outputs the image quality label “OK (confidence level of 90%)” having the highest confidence level among the confidence levels for each image quality class, to the selection unit 16.

The selection unit 16 that has accepted such input compares the voice quality label “NG (confidence level of 80%)” output by the first quality determination model M21 and the image quality label “OK (confidence level of 90%)” output by the second quality determination model M22. In this case, since the image quality is superior to the voice quality, the medium “image” having the better quality is selected from among the two media of voice and image. As a result, the genre “cultural program” corresponding to the medium “image” having the better quality is selected from among the genre label “sports program” output by the first genre determination model M11 and the genre label “cultural program” output by the second genre determination model M12.

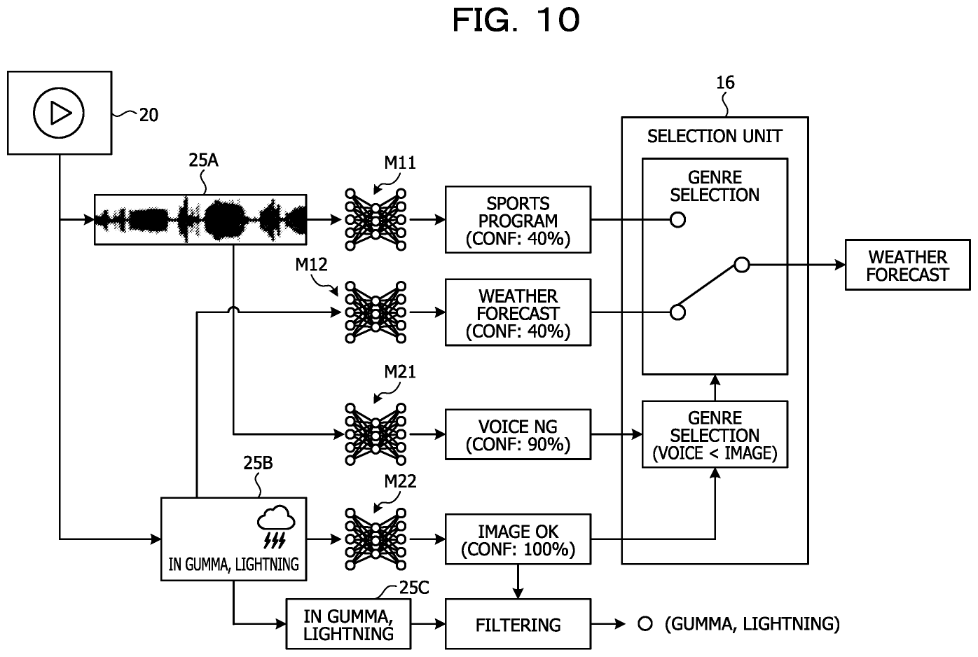

Finally, in FIG. 10, a section voice signal 25A is extracted by the voice extraction unit 12A from the section (e) of the moving image 20. In this case, the section voice signal 25A is input to the first genre determination model M11 and the first quality determination model M21. In addition, an example in which an image 25B is extracted by the image extraction unit 13 from the section (e) of the moving image 20 is illustrated. In this case, the image 25B is input to the second genre determination model M12 and the second quality determination model M22.

The first genre determination model M11 to which the section voice signal 25A has been input in this manner outputs the genre label “sports program (confidence level of 40%)” having the highest confidence level among the confidence levels for each genre class, to the selection unit 16. Furthermore, the second genre determination model M12 to which the image 25B has been input outputs the genre label “weather forecast (confidence level of 100%)” having the highest confidence level among the confidence levels for each genre class, to the selection unit 16. Furthermore, the first quality determination model M21 to which the section voice signal 25A has been input outputs the voice quality label “NG (confidence level of 90%)” having the highest confidence level among the confidence levels for each voice quality class, to the selection unit 16. Furthermore, the second quality determination model M22 to which the image 25B has been input outputs the image quality label “OK (confidence level of 100%)” having the highest confidence level among the confidence levels for each image quality class, to the selection unit 16.

The selection unit 16 that has accepted such input compares the voice quality label “NG (confidence level of 90%)” output by the first quality determination model M21 and the image quality label “OK (confidence level of 100%)” output by the second quality determination model M22. In this case, since the image quality is superior to the voice quality, the medium “image” having the better quality is selected from among the two media of voice and image. As a result, the genre “weather forecast” corresponding to the medium “image” having the better quality is selected from among the genre label “sports program” output by the first genre determination model M11 and the genre label “weather forecast” output by the second genre determination model M12.

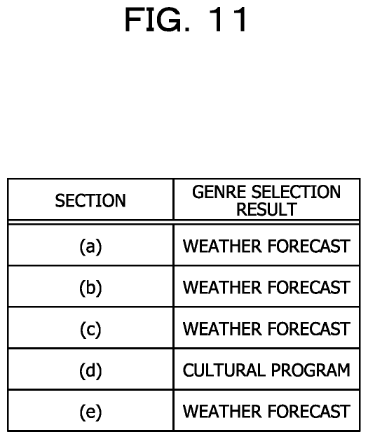

The selection results of selecting genres in each of these sections (a) to (e) are as illustrated in FIG. 11. FIG. 11 is a diagram illustrating an example of genre selection results. For example, as for the example of the genre “weather forecast” illustrated in FIG. 11, the number of instances, which is an example of the selection frequency, is “4”, and the probability, which is another example of the selection frequency, is “80%”. In addition, as for the example of the genre “cultural program” illustrated in FIG. 11, the number of instances, which is an example of the selection frequency, is “1”, and the probability, which is another example of the selection frequency, is “20%”. In this case, since the genre “weather forecast” has the highest selection frequency, the voice recognition dictionary corresponding to the genre “weather forecast” having the highest selection frequency among the genres selected for each of the sections (a) to (e) is selected from among the plurality of voice recognition dictionaries stored in the dictionary storage unit 16A.

Returning to the description of FIG. 1, the character extraction unit 17 is a processing unit that extracts characters from the image data extracted by the image extraction unit 13. As a mere example, the character extraction unit 17 may be implemented by a so-called optical character recognition (OCR) function. Such an OCR function may be implemented by image processing such as character feature extraction and pattern matching, or may be implemented by a machine learning model for a character recognition task.

Here, the character extraction unit 17 further extracts characters from the image extracted from the moving image by the image extraction unit 13, from the aspect of adding a vocabulary of a specified genre to the voice recognition dictionary selected by the selection unit 16, such as a word dictionary or a user dictionary that is a sort of the word dictionary. For this reason, the character extraction unit 17 may operate every time an image is extracted by the image extraction unit 13, such as for each section, but can also operate exclusively when the confidence level of the image quality determined by the second quality determination unit 15B is equal to or higher than a threshold value Th such as 70%.

This enables, when a character string having low relevance to the genre of the moving image is reproduced as on-screen subtitles or the like of the moving image, for example, to restrain a word or phrase relating to the on-screen subtitles from being registered in the voice recognition dictionary or to restrain resources from being consumed in extraction processing for such characters. For example, there is a case where on-screen subtitles of a prompt report such as a prompt report of the earthquake, a prompt report of the election, or a prompt report of the extra are inserted into the moving image. Since there is a high possibility that such on-screen subtitles have no connection with the purpose of creating or distributing the moving image, there is technical significance in restraining a word or phrase relating to the on-screen subtitles from being registered in the voice recognition dictionary.

The dictionary generation unit 18 is a processing unit that generates the voice recognition dictionary to be applied to the voice recognition engine, based on the selection result for the voice recognition dictionary by the selection unit 16 and the character extraction result by the character extraction unit 17. As a mere example, the dictionary generation unit 18 acquires the voice recognition dictionary selected by the selection unit 16 from among the plurality of voice recognition dictionaries stored in the dictionary storage unit 16A. Then, the dictionary generation unit 18 registers the word or phrase corresponding to the characters extracted by the character extraction unit 17 from the section in which the image quality determined by the second quality determination unit 15B is equal to or higher than the threshold value Th, in the voice recognition dictionary selected by the selection unit 16, such as the word dictionary or the user dictionary of the word dictionary.

For example, as for the examples of the sections (a) and (b) illustrated in FIGS. 6 and 7, since the image quality is not equal to or higher than the threshold value Th such as 70%, character extraction results 21C and 22C by the character extraction unit 17 are prohibited from being registered in the voice recognition dictionary. On the other hand, as for the examples of the sections (c) to (e) illustrated in FIGS. 8 to 10, since the image quality is equal to or higher than the threshold value Th such as 70%, character extraction results 23C, 24C, and 25C by the character extraction unit 17 are permitted to be registered in the voice recognition dictionary.

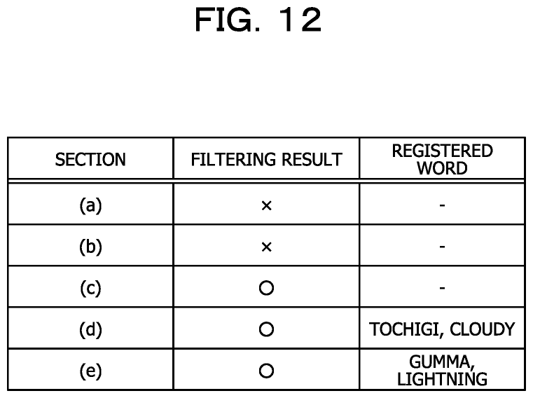

For example, the filtering results for the character extraction results by the character extraction unit 17 is as illustrated in FIG. 12. FIG. 12 is a diagram illustrating an example of the filtering results for the character extraction results. As illustrated in FIG. 12, the character extraction results 23C, 24C, and 25C in the sections (c) to (e) are permitted to be registered in the weather forecast dictionary selected by the selection unit 16. For example, the word “Tochigi” and the word “cloudy” extracted from the section (d) are added to the weather forecast dictionary. Furthermore, the word “Gunma” and the word “lightning” extracted from the section (e) are added to the weather forecast dictionary. Note that, as in the character extraction result 23C in the section (c), when no character is extracted, registration to the voice recognition dictionary may not be carried out as a matter of course.

Note that the condition that the image quality is equal to or higher than the threshold value Th has been given here as an example of the condition for registering a word or phrase in the voice recognition dictionary, but this is not restrictive. For example, registration of a word or phrase in the voice recognition dictionary may be carried out by focusing on a section in which a word that frequently appears in the on-screen subtitles, such as “earthquake”, “election”, “extra”, “prompt report” as an example, is not included in the character extraction result by the character extraction unit 17.

The voice recognition unit 19 is a processing unit that executes voice recognition. Such voice recognition may be implemented by any voice recognition engine as a mere example. As a mere example, the voice recognition unit 19 inputs the voice data of all sections extracted from the moving image by the voice extraction unit 12B to the voice recognition engine to which the voice recognition dictionary generated by the dictionary generation unit 18 is applied. This causes the voice recognition engine to output text data obtained by converting the voice data of all sections of the moving image into text, as a voice recognition result. Such a voice recognition result is supplied to the client terminal 30 as a response.

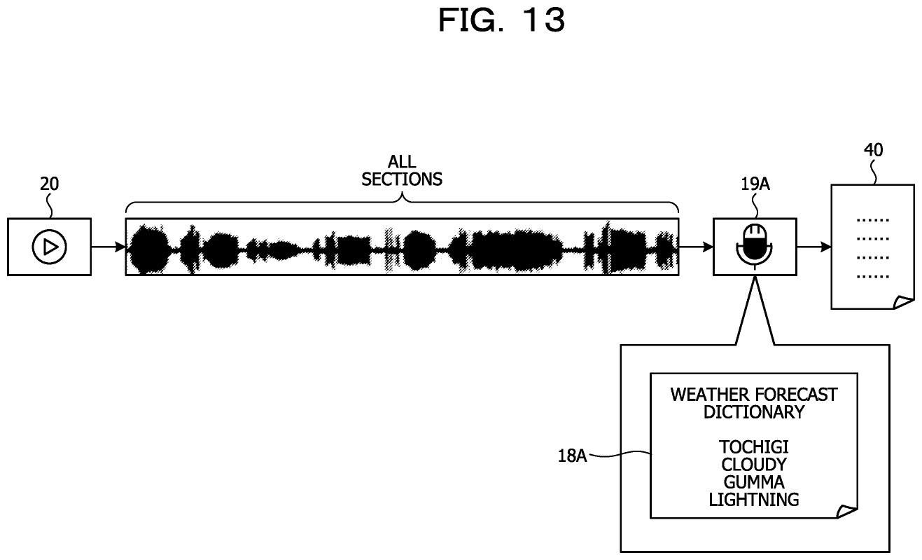

FIG. 13 is a diagram illustrating a schematic example of voice recognition. As illustrated in FIG. 13, voice signals in all sections are extracted from a moving image 20 by the voice extraction unit 12B. The voice signals in all the sections of the moving image 20 extracted in this manner are input to a voice recognition engine 19A to which a weather forecast dictionary 18A generated by the dictionary generation unit 18 is applied. This causes the voice recognition engine 19A to output text data obtained by converting the voice signals in all sections of the moving image 20 into text, as a voice recognition result 40. The voice recognition result 40 obtained in this manner is output to the client terminal 30 as a response to the speech-to-text transcription request.

<Processing Flow>

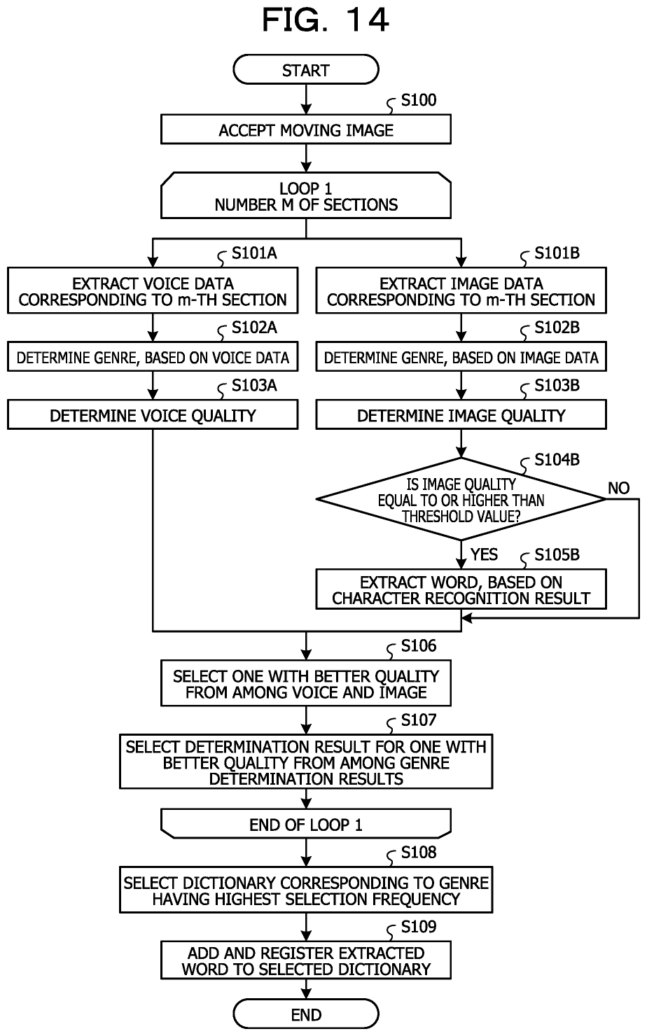

FIG. 14 is a flowchart illustrating a procedure of dictionary selection processing. This processing can be executed when a speech-to-text transcription request is accepted from the client terminal 30, as a mere example. As illustrated in FIG. 14, the acceptance unit 11 accepts a moving image designated as an object to be subjected to speech-to-text transcription (step S100).

Thereafter, loop processing 1 of repeating the processing from step S101 below to step S107 below is executed by the number of times corresponding to a number M of sections obtained by dividing the moving image accepted in step S100. Note that, although FIG. 14 gives an example in which the processing from step S101 to step S107 is repeated, the processing from step S101 to step S107 may be concurrently executed.

For example, the voice extraction unit 12A extracts the voice data corresponding to an m-th section of the moving image accepted in step S100 (step S101A). Then, the first genre determination unit 14A determines the genre of the m-th section, based on the voice data extracted in step S101A (step S102A). Furthermore, the first quality determination unit 15A determines the voice quality of the m-th section, based on the voice data extracted in step S101A (step S103A).

Note that, although an example in which the processing is executed in the order of steps S102A and S103A has been given in FIG. 14, steps S102A and S103A can be executed in any order.

In parallel with the processing from these step S101A to step S103A, the processing from step S101B to step S105B is executed.

For example, the image extraction unit 13 extracts the image data corresponding to the m-th section of the moving image accepted in step S100 (step S101B). Then, the second genre determination unit 14B determines the genre of the m-th section, based on the image data extracted in step S101B (step S102B). Furthermore, the second quality determination unit 15B determines the image quality of the m-th section, based on the image data extracted in step S101B (step S103B).

At this time, when the confidence level of the image quality is equal to or higher than the threshold value Th such as 70% (Yes in step S104B), the character extraction unit 17 extracts characters from the image data extracted in step S101B (step S105B). Note that, when the confidence level of the image quality is lower than the threshold value Th such as 70% (No in step S104B), the processing in step S105B is skipped.

Thereafter, the selection unit 16 compares the voice quality determined in step S103A and the image quality determined in step S103B, thereby selecting a medium with the better quality from among the two media of voice and image (step S106).

Then, the selection unit 16 selects the genre corresponding to the medium with the better quality selected in step S106 from among the genre determined from the voice in step S102A and the genre determined from the image in step S102B (step S107).

By repeating such loop processing 1, the selection results for the genre are obtained for each of the M sections obtained by dividing the moving image.

After that, the selection unit 16 selects the voice recognition dictionary corresponding to the genre having the highest selection frequency among the genres selected for each section, from among the plurality of voice recognition dictionaries stored in the dictionary storage unit 16A (step S108).

Then, the dictionary generation unit 18 registers the word or phrase corresponding to the characters extracted in step S105B, in the voice recognition dictionary selected in step S108, such as the word dictionary or the user dictionary of the word dictionary, among the plurality of voice recognition dictionaries in the dictionary storage unit 16A (step S109).

<One Aspect of Effects>

As described above, the server device 10 according to the present embodiment resolves which of the genre determined from the voice or the genre determined from the image in the moving image is used for selection of the voice recognition dictionary, based on the quality of the voice and the image.

This may enable, for example, to select a voice recognition dictionary corresponding to the genre determined from the voice when the image has a poor quality in the moving image, or to select a voice recognition dictionary corresponding to the genre determined from the image when the voice has a poor quality in the moving image. Alternatively, for example, a voice recognition dictionary corresponding to the genre determined from the image may be selected when the image has a good quality in the moving image, or a voice recognition dictionary corresponding to the genre determined from the voice may be selected when the voice has a good quality in the moving image.

Therefore, according to the server device 10 according to the present embodiment, selection of a voice recognition dictionary corresponding to a genre of a moving image may be implemented.

### Second Embodiment

Incidentally, while the embodiments relating to the disclosed device have been described above, the embodiments may be carried out in a variety of different modes apart from the embodiments described above. Thus, in the following, other embodiments included in the embodiments will be described.

### Application Examples

The first embodiment described above has given an example in which the genre is selected based on the voice quality and the image quality when selecting the genres for each section, but is not limited to this. For example, it is also possible to select a genre having a higher confidence level from among the confidence level of the genre output by the first genre determination model M11 and the confidence level of the genre output by the second genre determination model M12. In this case, the determination of the voice quality and the image quality does not necessarily have be executed.

<Distribution and Integration>

In addition, each component of each of the illustrated devices does not necessarily have to be physically configured as illustrated in the drawings. For example, specific modes of distribution and integration of each device are not limited to those illustrated, and the whole or a part of each device may be configured by being functionally or physically distributed and integrated in any unit depending on various loads, use situations, or the like. For example, the acceptance unit 11, the voice extraction units 12A and 12B, the image extraction unit 13, the first genre determination unit 14A, the second genre determination unit 14B, the first quality determination unit 15A, the second quality determination unit 15B, the selection unit 16, the character extraction unit 17, the dictionary generation unit 18, or the voice recognition unit 19 may be coupled through a network as an external device of the server device 10. In addition, different devices may include one of the acceptance unit 11, the voice extraction units 12A and 12B, the image extraction unit 13, the first genre determination unit 14A, the second genre determination unit 14B, the first quality determination unit 15A, the second quality determination unit 15B, the selection unit 16, the character extraction unit 17, the dictionary generation unit 18, or the voice recognition unit 19 and coupled to a network to cooperate with each other, thereby implementing the function of the server device 10.

<Hardware Configuration>

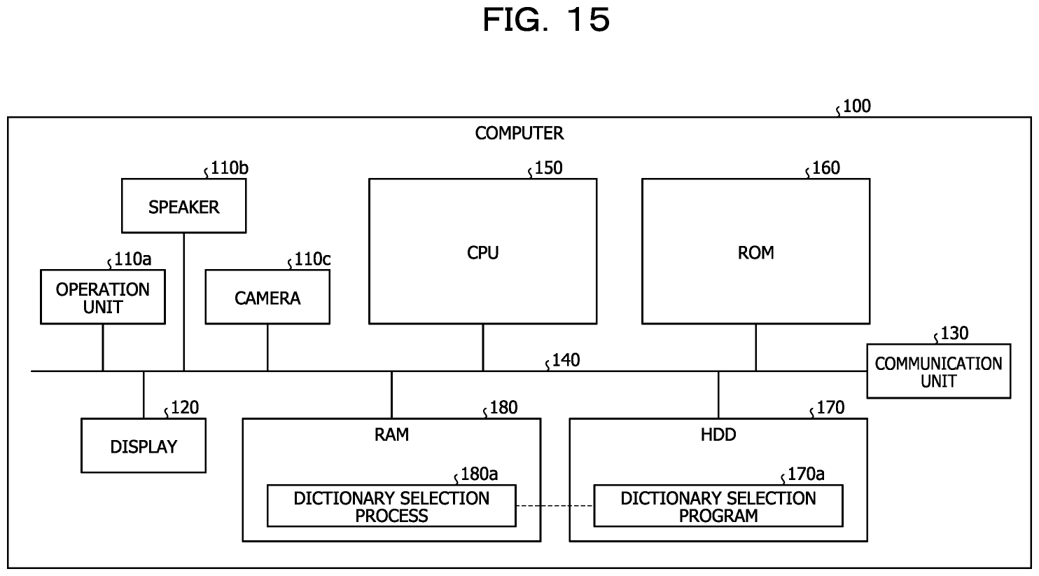

In addition, various types of processing described in the above embodiments can be implemented by a computer such as a personal computer or a workstation executing a program prepared in advance. Thus, in the following, an example of a computer that executes a dictionary selection program having functions similar to the functions in the first and second embodiments will be described with reference to FIG. 15.

FIG. 15 is a diagram illustrating a hardware configuration example. As illustrated in FIG. 15, a computer 100 includes an operation unit 110a, a speaker 110b, a camera 110c, a display 120, and a communication unit 130. Furthermore, this computer 100 includes a CPU 150, a read only memory (ROM) 160, an HDD 170, and a random access memory (RAM) 180. These units 110 to 180 are coupled to each other via a bus 140. Note that the CPU 150 has been given here as an example of the hardware processor, but may be implemented by a GPU, a GPU cluster, or the like.

As illustrated in FIG. 15, the HDD 170 stores a dictionary selection program 170a that boasts functions similar to the functions of the acceptance unit 11, the voice extraction unit 12A, the image extraction unit 13, the first genre determination unit 14A, the second genre determination unit 14B, the first quality determination unit 15A, the second quality determination unit 15B, the selection unit 16, the character extraction unit 17, and the dictionary generation unit 18 illustrated in the first embodiment described above. This dictionary selection program 170a may be integrated or separated similarly to the respective components of the acceptance unit 11, the voice extraction unit 12A, the image extraction unit 13, the first genre determination unit 14A, the second genre determination unit 14B, the first quality determination unit 15A, the second quality determination unit 15B, the selection unit 16, the character extraction unit 17, and the dictionary generation unit 18 illustrated in FIG. 1. For example, all pieces of data indicated in the above first embodiment do not necessarily have to be stored in the HDD 170, and it is sufficient that data for use in processing is stored in the HDD 170.

Under such an environment, the CPU 150 reads the dictionary selection program 170a from the HDD 170 and then loads the read dictionary selection program 170a into the RAM 180. As a result, the dictionary selection program 170a functions as a dictionary selection process 180a as illustrated in FIG. 15. This dictionary selection process 180a loads various types of data read from the HDD 170 into an area allocated to the dictionary selection process 180a in a storage area included in the RAM 180 and executes various types of processing using the various types of loaded data. For example, examples of the processing to be executed by the dictionary selection process 180a can include the processing illustrated in FIG. 14, and the like. Note that all the processing units indicated in the first embodiment described above do not necessarily have to operate in the CPU 150, and it is sufficient that a processing unit corresponding to processing to be executed is virtually implemented.

In addition, the dictionary selection program 170a described above does not necessarily have to be stored in the HDD 170 or the ROM 160 from the beginning. For example, the dictionary selection program 170a is stored in a “portable physical medium” to be inserted in the computer 100, such as a flexible disk, which is a so-called FD, a compact disc (CD)-ROM, a digital versatile disc (DVD) disk, a magneto-optical disk, or an integrated circuit (IC) card. Then, the computer 100 may acquire and execute the dictionary selection program 170a from those portable physical media. In addition, the dictionary selection program 170a is stored in another computer, a server device, or the like coupled to the computer 100 via a public line, the Internet, a LAN, a wide area network (WAN), or the like. The computer 100 may be caused to download the dictionary selection program 170a stored in this manner and then caused to execute the downloaded dictionary selection program 170a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a dictionary selection program for causing a computer to execute a process comprising:
determining genres indicated by moving image data for each of a plurality of sections in the moving image data, based on each of voice data and image data of the moving image data;
determining quality of voice and the quality of an image for each of the plurality of sections in the moving image data, based on each of the voice data and the image data; and
selecting voice recognition dictionaries that are specified, from among a plurality of the voice recognition dictionaries, based on determination results for the genres and the determination results for the quality of the voice and the quality of the image for each of the plurality of sections.

2. The non-transitory computer-readable recording medium according to claim 1, wherein
the selecting includes: comparing, for each of the sections included in the plurality of sections, the quality of the voice and the quality of the image to select a medium with better quality from among the voice and the image; selecting, for each of the sections, the genres that correspond to the medium with the better quality from among the genres determined from the voice data and the genres determined from the image data; and selecting the voice recognition dictionaries that correspond to the genres with a highest selection frequency among the genres selected for each of the sections.

3. The non-transitory computer-readable recording medium according to claim 1, further comprising:
extracting a character included in the image data for each of the plurality of sections; and
registering a word or a phrase that corresponds to the extracted character, in the voice recognition dictionaries selected in the selecting.

4. The non-transitory computer-readable recording medium according to claim 3, wherein
the extracting includes extracting the character included in the image data for the sections in which the quality of the image satisfies a specified condition among the plurality of sections.

5. The non-transitory computer-readable recording medium according to claim 3, wherein
the registering includes registering the word or the phrase that corresponds to the character extracted from the sections in which the quality of the image satisfies the specified condition among the plurality of sections, in the voice recognition dictionaries selected in the selecting.

6. The non-transitory computer-readable recording medium according to claim 1, further comprising
executing voice recognition on the voice data of the moving image data by using the voice recognition dictionaries selected in the selecting.

7. A dictionary selection method comprising:
determining genres indicated by moving image data for each of a plurality of sections in the moving image data, based on each of voice data and image data of the moving image data;
determining quality of voice and the quality of an image for each of the plurality of sections in the moving image data, based on each of the voice data and the image data; and
selecting voice recognition dictionaries that are specified, from among a plurality of the voice recognition dictionaries, based on determination results for the genres and the determination results for the quality of the voice and the quality of the image for each of the plurality of sections.

8. The dictionary selection method according to claim 7, wherein
the selecting includes: comparing, for each of the sections included in the plurality of sections, the quality of the voice and the quality of the image to select a medium with better quality from among the voice and the image; selecting, for each of the sections, the genres that correspond to the medium with the better quality from among the genres determined from the voice data and the genres determined from the image data; and selecting the voice recognition dictionaries that correspond to the genres with a highest selection frequency among the genres selected for each of the sections.

9. The dictionary selection method according to claim 7, further comprising:
extracting a character included in the image data for each of the plurality of sections; and
registering a word or a phrase that corresponds to the extracted character, in the voice recognition dictionaries selected in the selecting.

10. The dictionary selection method according to claim 9, wherein
the extracting includes extracting the character included in the image data for the sections in which the quality of the image satisfies a specified condition among the plurality of sections.

11. The dictionary selection method according to claim 9, wherein
the registering includes registering the word or the phrase that corresponds to the character extracted from the sections in which the quality of the image satisfies the specified condition among the plurality of sections, in the voice recognition dictionaries selected in the selecting.

12. The dictionary selection method according to claim 7, further comprising
executing voice recognition on the voice data of the moving image data by using the voice recognition dictionaries selected in the selecting.

13. A dictionary selection device comprising:
a memory; and
a processor coupled to the memory and configured to:
determine genres indicated by moving image data for each of a plurality of sections in the moving image data, based on each of voice data and image data of the moving image data;
determine quality of voice and the quality of an image for each of the plurality of sections in the moving image data, based on each of the voice data and the image data; and
select voice recognition dictionaries that are specified, from among a plurality of the voice recognition dictionaries, based on determination results for the genres and the determination results for the quality of the voice and the quality of the image for each of the plurality of sections.

14. The dictionary selection device according to claim 13, wherein the processor:
compares, for each of the sections included in the plurality of sections, the quality of the voice and the quality of the image to select a medium with better quality from among the voice and the image;
selects, for each of the sections, the genres that correspond to the medium with the better quality from among the genres determined from the voice data and the genres determined from the image data; and
selects the voice recognition dictionaries that correspond to the genres with a highest selection frequency among the genres selected for each of the sections.

15. The dictionary selection device according to claim 13, wherein the processor:
extracts a character included in the image data for each of the plurality of sections; and
registers a word or a phrase that corresponds to the extracted character, in the voice recognition dictionaries.

16. The dictionary selection device according to claim 15, wherein the processor extracts the character included in the image data for the sections in which the quality of the image satisfies a specified condition among the plurality of sections.

17. The dictionary selection device according to claim 15, wherein the processor registers the word or the phrase that corresponds to the character extracted from the sections in which the quality of the image satisfies the specified condition among the plurality of sections, in the voice recognition dictionaries.

18. The dictionary selection device according to claim 13, wherein the processor executes voice recognition on the voice data of the moving image data by using the voice recognition dictionaries.
